(19) United States
(12) Patent Application Publication
(10) Pub. No.: US 2020/0001284 A1
(43) Pub. Date: Jan. 2, 2020

(54) ACCELERATED METHOD FOR PREPARING HYDROCARBON-SOLUBLE MOLYBDENUM CATALYST PRECURSORS UNDER PRESSURE

(71) Applicant: Everblue Hydrogen Technologies Inc., Gloucester (CA)

(72) Inventor: Xie Jinhai, Gloucester (CA)

(21) Appl. No.: 16/477,770

(22) PCT Filed: Jan. 15, 2018
(86) PCT No.: PCT/CA2018/000012

§ 371 Date: Jul. 12, 2019

Related U.S. Application Data
(60) Provisional application No. 62/449,058, filed on Jan. 22, 2017.
(60) Provisional application No. 62/446,400, filed on Jan. 14, 2017.

(51) Int. Cl. B01J 31/04; B01J 23/28; B01J 33/00; C10G 47/02; C10G 45/46; C10G 45/34

(52) U.S. Cl. CPC B01J 31/04; B01J 23/28; B01J 33/00; C10G 2300/70; C10G 45/46; C10G 45/34; B01J 2531/64; C10G 47/02

(57) ABSTRACT

This present invention relates to the preparation of hydrocarbon-soluble molybdenum catalyst precursors by reacting molybdenum compounds with carboxylic acids. During the reaction, vacuum was applied to accelerate removal of the water produced and to improve the conversion of reactants when reaction was carried out at low temperatures, in the range of 100-200° C. A high controlled heating temperature was employed to increase the conversion of the reactants. Vacuum was also used after the reaction process to accelerate the removal of non-reacted carboxylic acid so as to increase the concentration of produced catalyst precursors. The catalyst precursors can generate, in situ, a hydroprocessing molybdenum sulphide catalyst during heavy oil or residue upgrading.

### REFERENCES CITED

U.S. Pat. Nos. DOCUMENT

| | | | |
|---|---|---|---|
| 3,362,972 A | January 1968 | Kollar | 260/414 |
| 3,595,891 A | July 1971 | Cavitt | 260/429 |
| 3,578,690 A | May 1971 | Becker | 260/414 |
| 5,578,197 A | November 1996 | Cyr et al. | 208/112 |
| 6,660,157 B2 | December 2003 | Que et al. | 208/108 |
| 7,842,635 B2 | November 2010 | Zhou et al. | 502/150 |
| 8,445,399 B2 | May 2013 | Wu et al. | 502/150 |
| 9,403,153 B2 | August 2016 | Qiu et al. | 208/112 |

### OTHER PUBLICATIONS

Gray, M. R., Upgrading Petroleum Residue and Heavy Oils, Marcel Dekker, New York, 1994, p. 83

### BACKGROUND OF THE INVENTION

### 1. Field of the Invention

The present invention stems from the field of preparing molybdenum salts which can be used in hydroconverting heavy oil or residue (both atmospheric and vacuum) feedstock. It relates, more particularly to the process of preparing hydrocarbon-soluble molybdenum salts through a direct reaction of molybdenum compounds with carboxylic acids which contains a range of 5-40 carbons. It relates, most particularly to the process of preparing a molybdenum catalyst by which a vacuum is employed to extract the water produced when the preparation temperature is below 200° C. A heating element regulated at a higher controlled temperature is employed to increase the conversion of Mo. Further, in order to increase the conversion of Mo, a higher ratio of acid/Mo can be used as the removal of surplus carboxylic acid in the generated product is carried out through the brief exposure to vacuum shortly after the reaction is complete.

### 2. Introduction of Related Technologies

With the increasing worldwide demand for refined fossil fuels and the declining availability of light conventional oil, scientists and engineers have been stimulated to find ways to exploit low quality fuels, upgrade them into better quality oils so they may ultimately, be used in refineries. Currently, the most recognized and abundant energy source in the world is heavy petroleum which includes heavy oils, extra heavy oils/bitumen, and shale oils. Heavy hydrocarbon oils are heavy petroleum and residual oils obtained through petroleum atmosphere distillation tower residua (boiling point above 343° C.) and vacuum distillation residua (boiling point above 524° C.). In the refining process, heavy hydrocarbon oils are considered an undesirable feedstock since they contain heavy molecular weight compounds and high concentrations of metal (Ni, V, Fe) and heteroatom (S, N, O) contents which can result in the formation of coke and thus, deactivate the catalysts and block the reactors. Therefore, the aims (Gray, M. R., Upgrading Petroleum Residue and Heavy Oils, Marcel Dekker, New York, 1994, p. 83) of upgrading heavy hydrocarbon oils are to (a) convert high molecular weight residue components to distillate with a boiling range below 300° C. This conversion requires the breakage of the C—C and C—S bonds in the residue fraction with mild hydrocracking in the presence of an acid catalyst; (b) increase the molar H/C ratio of the distillated products towards 1.8 as required for fuel transportation. This is essentially done by adding hydrogen (hydrogenation) and breaking the molecular bonds (cracking); (c) reduce metals (Ni, V, Fe) and heteroatoms (S, N, O) contents to acceptable levels in order to comply with environmental standards.

Hydroconversion is considered the most efficient process to convert heavy oil and residue feedstocks into low boiling points, so as to achieve a high H/C ratio, which in turns produces a high quality, and higher value liquid. Over time, several technologies were developed for heavy oil and residue hydroconversion.

Commercially, the commonly used technology is based on fixed bed reactors. Such techniques employ heterogeneous catalysts, such as sulfide cobalt, molybdenum and nickel supported on silica or alumina-silica. This technology has been used for decades and has been the benchmark in the industry due to its simplicity and reliable performance. However, this technology has its disadvantages, namely, the catalyst is very sensitive to poisons such as coke and heavy metals (Ni, V) found in heavy oils and residue feedstocks. Due to the quick deactivation of the catalyst by coke and heavy metals, a fixed bed technology can only use a sweet feedstock which contains less heavy metal and less asphaltene. Other than the above-mentioned demerits, further deficiencies in a fixed bed technology include pressure drops and uneven temperature distribution in the bed.

In the industry, another wide spread means for hydroconversion of heavy oil and residue is an ebullated bed reactor, in which, supported catalysts are used. This technology supports the processing of feedstock that contains more asphaltene and heavy metals. However, its low conversion yield (less than 80%) and high investment costs for equipment make it less broadly used compared to a fixed bed technology. The predominant disadvantage of supported catalysts employed in hydroconversion of heavy hydrocarbon oils is the deactivation of the catalysts caused by coke and pore-mouth plugging. Therefore, the finding of a suitable alternative to supported catalysts is desirable. For the past two decades, unsupported (dispersed) catalysts, which are used in slurry reactors, have been of great interest in the hydroconversion of heavy hydrocarbon oils over supported catalysts as they provide for a higher inhibition of coke formation, a high catalytic metal utilization due to the absence of diffusion limitations, a good temperature profile in the reactor, no pressure drops, accessible active sites allowing large complex molecules to reach the catalyst actives sites, and, the replacement of a deactivated catalyst bed is unnecessary.

The promising dispersed catalyst for hydroconversion of heavy hydrocarbon oils is oil soluble catalyst precursors which decompose in heavy hydrocarbon oils during hydroconversion and generate, in-situ, processing catalysts. U.S. Pat. No. 5,578,197 disclosed the application of oil soluble metal containing compounds such as iron pentacarbonyl, molybdenum 2-ethyl hexanoate as catalyst precursors for heavy oil upgrading. U.S. Pat. No. 7,670,984 disclosed a method of synthesis of hydrocarbon soluble molybdenum salts as heavy oil hydroconversion catalyst precursors. The catalyst precursor described therein includes a plurality of molybdenum cations that are each bonded with a plurality of organic anions to form an oil soluble molybdenum salt.

During the preparation of this oil soluble molybdenum salt, reducing agents, such as hydrogen gas, is employed to obtain the molybdenum in the desired oxidation state. U.S. Pat. No. 3,362,972 disclosed the preparation of hydrocarbon-soluble salts of Mo and V with the help of oxalic acid. However, the concentration of metal is low, around 5 wt %. U.S. Pat. No. 3,578,690 disclosed a process for preparing molybdenum acid salt, which is used as a catalyst for olefin epoxidation. The method detailed therein required the direct reaction of a molybdenum compound with a carboxylic acid at elevated temperatures. Azeotropic agents, such as ethylbenzene, octane, xylene isomers or cumene, were used to remove the water from the reaction. Through a long reaction time (48 hours), a high molybdenum carboxylate concentration solution (˜15 wt % Mo) was produced.

Due to the single use limitations of this kind of catalyst during the hydroconversion of heavy hydrocarbon feedstocks, the main problem in commercialization of such a hydrocarbonsoluble molybdenum based catalyst precursor is the preparation costs associated with Mo-based catalyst precursors. The main costs in Mo-based oil soluble catalyst precursors are the long synthesis periods and low concentrations of molybdenum salt obtained. In order to reduce production costs in Mo-based oil soluble catalyst precursors used in the hydroconversion of heavy hydrocarbon feedstocks, U.S. Pat. No. 7,842,635 disclosed hydrocarbon soluble bimetallic catalyst precursors. It is claimed that the bimetallic catalyst precursors can be manufactured more economically than molybdenum-only catalysts due to the lower price of many of the secondary transition metals (e.g., iron, nickel, cobalt, and manganese). However, no matter what catalysts are used in the hydroconversion of heavy hydrocarbon feedstocks, the primary metal component of the hydrocarbon soluble catalyst precursors is molybdenum. As such, the use of a Mo-based catalyst cannot be avoided. Accordingly, the main element for heavy hydrocarbon feedstocks hydroprocessing is still molybdenum.

It is well known in the art and accepted that the most important catalytic metallic element for heavy hydrocarbon feedstocks hydroconversion catalysts is molybdenum. Accordingly, for those versed in the field, it has become of paramount importance to find means to prepare hydrocarbon-soluble molybdenum-based catalyst precursors inexpensively. It is further appreciated that the prepared molybedenum catalyst precursors must yield relatively high Mo concentrations. The preparation costs relate to raw material costs and time consumption during the synthesis of hydrocarbon soluble catalyst precursors. As such, in order to reduce the costs of Mo-based catalyst precursors, using a shorter time span and employing relatively inexpensive molybdenum compounds that are readily available (commercially) are desirable.

It is therefore the primary object of the present invention to provide a method for preparing oil soluble Mo-based catalytic precursors with high Mo concentrations in a short synthesis time.

It is a further object of the present invention to provide a method for preparing an oil soluble Mo-based catalytic precursor wherein the starting materials are relatively inexpensive.

A crucial embodiment of this invention is to provide a hydrocarbon soluble catalyst precursor which has high coke suppression performance during heavy oil or vacuum residue hydroprocessing so as to allow prolonged and/or repeated hydroprocessing.

### BRIEF SUMMARY OF THE INVENTION

According to the present invention, a method is provided for preparing a catalyst precursor having hydrocarbon soluble molybdenum salt which can be vulcanized, in situ, to molybdenum sulphide for the hydroconversion of heavy hydrocarbon feedstock wherein the method comprises the steps of (1) providing a molybdenum source; (2) providing a carboxylic acid, preferably having 5 to 40 carbon atoms, more preferably having 6 to 20 carbon atoms; (3) reacting the molybdenum source with carboxylic acid at a temperature between 100° C. and the boiling point of carboxylic acid; (4) a reaction temperature between ambient temperature to 200° C., where a vacuum is applied to accelerate the removal of water so as to reduce the synthesis time; (5) while the temperature of carboxylic acid's boiling point is preferably achieved in the final step of synthesis; (6) application of a higher heating temperature even when the carboxylic acid in the reaction vessel has already reached its boiling point. The proposed higher heating temperature improves the conversion of Mo; (7) while Mo conversions can be improved by increasing the ratio of acid/Mo, thus removing extra non-reacted acid by vacuum in a short timeframe after the reaction is complete. Once the surplus acid is removed a Mo concentration increase is resulted.

### DETAILS OF THE DESCRIPTION OF THE INVENTION

The present invention relates to hydrocarbon soluble molybdenum catalyst precursors that can form, in situ, activating hydroproccssing molybdenum catalysts, during hydroconversion of heavy hydrocarbon feedstock. The instant invention relates to methods of manufacturing and using the hydrocarbon-soluble molybdenum catalyst precursors.

The molybdenum component used to prepare the hydrocarbon soluble molybdenum catalyst precursors may include molybdenum in any oxidation state. The molybdenum component used in the preparation of the hydrocarbon soluble molybdenum catalyst precursors may be molybdenum compounds including, but not limited to, molybdenum hexacarbonyl, molybdic acid, alkali metal molybdates, alkaline earth metal molybdates, ammonium molybdate, ammonium dimolybdate, ammonium heptamolybdate, ammonium tetrathiomolybdate, molybdenum halides, molybdenum oxide halides such as MoOCl₄, MoO₂Cl₂, MoO₂Br₂, and Mo₂O₃Cl₆. The preferred molybdenum components are molybdenum trioxide, molybdic acid and those components derived from molybdic acid and ammonium molybdate. A particularly preferred molybdenum component is molybdic acid.

The carboxylic acid used in the preparation of the hydrocarbon soluble molybdenum catalyst precursors may be one or more carboxylic acids having at least one carboxylate group, with carbon atoms ranging from 5 to 40. The carboxylic acids include aliphatic acids, alicyclic acids, and aromatic acids. It can be monocarboxylic acid, dicarboxylic acids and tricarboxylic acids. The catalyst precursors with short chain anions may have higher Mo concentrations while its solubility in hydrocarbons is low. However, the catalyst precursors with long chain anions may yield increased solubility in hydrocarbons, while its Mo concentration is low which correlatively results in the additional costs for raw materials. For the purpose of obtaining high Mo concentrations as well as better solubility of the catalyst precursor in hydrocarbons, the carboxylic acid had better have appropriate carbon atoms. The preferred carboxylic acids are the ones with carbon atoms ranging from 6 to 22, while the more preferred carboxylic acids are the ones containing carbon atoms ranging between 7 and 18.

Suitable organic agents include heptanoic acid, octanoic acid, decanoic acid, 2-ethylhexanoic acid, and the like.

The molar ratio of carboxylic acid molecules to molybdenum atoms is preferably less than 15:1, more preferably in the range 3:1 to 10:1, and most preferably in a ratio of 4:1-6:1. A higher ratio can increase the conversion of Mo. With a reaction condition that provides for a higher ratio of carboxylic acid to Mo atoms, the extra non-reacted carboxylic acid can be removed by vacuum after the reaction process in order to enhance the concentration of Mo in the catalyst precursors without greatly increasing the synthesis time.

The optimal reaction temperature for synthesizing hydrocarbon soluble catalyst precursors depends on the particular carboxylic acid being used. The preferred temperature of the reactant mixture in the reactor is typically between 100° C. and 320° C., more preferably between 150° C. and 300° C., and most preferably between 180° C. and 250° C., at the boiling temperature of the carboxylic acids used. It is to be noted that the controlled temperature of the furnace or heating mantle or oil bath which is employed for heating the reactor is an important factor. Its temperature is typically controlled between 120° C. and 400° C., more preferably between about 200° C. and 380° C., and most preferably between 200° C. and about 350° C.

Water removal from the reaction vessel is crucial since the removal of water can improve the chemical equilibrium shift. During the synthesis of catalyst precursors, water must be removed out the reactor vessel. Water removal can be carried out by using a single technique or a combination of two or more techniques. The technique includes, but not being limited to, a temperature that is higher than water's boiling point at synthesis pressure, bubbling the reactant mixture with inert gases, azeotropic reagents and drying reagents, such as calcium chloride, polyacrylic acid, etc. In the present invention, a vacuum combined with a reaction temperature exceeding the boiling point of water are employed for accelerating the removal of water, thus, improving the chemical equilibrium shift, shortening the synthesis time, and increasing the conversion of Mo.

In the present invention, the produced hydrocarbon soluble molybdenum based catalyst precursors can be mixed with hydrocarbons to avoid or reduce the chance for Mo concentration variations with the time stream. The preferred hydrocarbons are in liquid state and solid state at atmospheric temperature. The most preferred hydrocarbons used to protect the catalyst precursors are in solid state at atmospheric temperature. The final state of catalyst precursors are in solid state. The solid hydrocarbons include, but are not limited to, for example, wax, vacuum residue, hydrogenated vegetable oils etc. Finally, the achieved solid state catalyst precursors not only avoid Mo concentration variations, but also facilitates transportation. The weight ratio of hydrocarbon soluble catalyst precursors with protecting hydrocarbons varies depending on the type of hydrocarbon employed. The ratio is preferably in the range of 1:1 to 1:4, which is really dependent on the melding point of hydrocarbon.

The mixing apparatus of solid hydrocarbons with catalyst precursors include, but are not limited to, high shear mixing in a bath. Preferably mixed at a temperature in a range of 40° C. to 350° C., more preferably in a range of 75° C. to 300° C., and most preferably in a range of about 75° C. to about 180° C. The temperature provides a sufficiently low viscosity so as to allow adequate mixing of the catalyst precursor into the hydrocarbons. After adequate mixing, the mixture is then dropped onto a moving cold metal surface to finally become a solid bean. The catalyst precursor is preferably mixed with the solid hydrocarbons at the most preferred temperature for a time period ranging between 1 minute to 30 minutes, more preferably in a range of 3 minutes to 20 minutes, and most preferably in a range of about 5 minutes to 10 minutes.

The catalyst employed for heavy hydrocarbons hydroconversion is molybdenum disulfide. In order to form the catalyst from a catalyst precursor, a sulfidation process is necessary.

Heavy hydrocarbon feedstock usually contains organosulfur. In the instances where the heavy hydrocarbon feedstock includes sufficient or excess sulfur, the sulfidation process can be simply performed, in situ, by heating the heavy hydrocarbon feedstock to a certain temperature in hydrogen atmosphere. In cases where the heavy hydrocarbon feedstock contains insufficient organosulfur, a sulphur reagent then needs to be added into the heavy hydrocarbon feedstock. The sulfidation temperature is preferably heated in the range of 200° C. to 430° C., more preferably in the range of 280° C. to 380° C., and most preferably in a range of approximately 300° C. to 360° C.

The hydroprocessing catalyst can be used in various reactors, such as a slurry reactor, an ebullated reactor, a trickle bed reactor, a batch reactor and even a fixed bed reactor for hydroconversion of heavy hydrocarbon feedstock. The hydroprocessing catalyst described in the present invention can effectively depress the formation of coke precursors and sediment, so as to reduce equipment fouling and ensure the continued hydroprocessing of the heavy hydrocarbon feedstock.

### EXAMPLES

The following examples illustrate the present invention in more detail but are not intended to limit the scope of the invention. Examples 1, 2, 3, 4 and 5 illustrate the influence of temperature on the synthesis of hydrocarbon soluble molybdenum carboxylate. Examples 5 and 6 illustrate the influence of reaction time on the synthesis of hydrocarbon soluble molybdenum carboxylate. Examples 4 and 7 illustrate the influence of reactant ratios on the synthesis of hydrocarbon soluble molybdenum carboxylate. Examples 1 and 8 illustrate the influence of low vacuum on the synthesis of hydrocarbon soluble molybdenum carboxylate. Examples 7 and 9 illustrate the removal of non-reacted carboxylic acid results in the increase of Mo concentrations. Example 11 illustrates the process for protecting the catalyst precursor from Mo concentration changes during storage. Example 12 illustrates the use of a metal salt prepared by the present invention as a catalyst precursor for the hydroconversion of heavy hydrocarbon feedstock.

### Example 1

20 grams of molybdic acid (Alfa Aecar) and 72 gram of 2-ethylhexanoic acid (Aldrich) were combined in a 500 ml three neck flask. The flask was equipped with a magnetic stirring bar, a Dean-Stark Trap, a condenser, two one end sealed tube for thermal couples. The flask was heated with a heating mantle and this heating mantle was set on a magnetic stirrer. The heating mantle was controlled at 200° C., while the mixture temperature in the flask was in the 150-161° C. range and the overhead mixture temperature was in the range of 131−143° C. Kept in these reaction conditions, combined with stirring for 6 hours, then filtered, the liquid product obtained resulted in the yield a molybdenum salt with 0.61 wt % Mo and a molybdic acid conversion of 3.7 wt %.

### Example 2

20 grams of molybdic acid (Alfa Aecar) and 72 gram of 2-ethylhexanoic acid (Aldrich) were combined in a 500 ml three neck flask. The flask was equipped with a magnetic stirring bar, a Dean-Stark Trap, a condenser, two one end sealed tube for thermal couples. The flask was heated with a heating mantle and this heating mantle was set on a magnetic stirrer. The heating mantle was controlled at 240° C., while the mixture temperature in the flask was in a 194-198° C. range and the overhead mixture temperature was in the range of 171-175° C. Kept in these reaction conditions, combined with stirring for 6 hours, then filtered, the liquid product obtained resulted in the yield a molybdenum salt with 2.58 wt % Mo and a molybdic acid conversion of 15.5 wt %.

### Example 3

20 grams of molybdic acid (Alfa Aecar) and 72 gram of 2-ethylhexanoic acid (Aldrich) were combined in a 500 ml three neck flask. The flask was equipped with a magnetic stirring bar, a Dean-Stark Trap, a condenser, two one end sealed tube for thermal couples. The flask was heated with a heating mantle and this heating mantle was set on a magnetic stirrer. The heating mantle was controlled at 275° C., while the mixture temperature in the flask was in a 218-219° C. range and the overhead mixture temperature was in the range of 210-214° C. Kept in these reaction conditions, combined with stirring for 6 hours, then filtered, the liquid product obtained resulted in the yield a molybdenum salt with 8.32 wt % Mo and a molybdic acid conversion of 53.4 wt %

### Example 4

20 grams of molybdic acid (Alfa Aecar) and 72 gram of 2-ethylhexanoic acid (Aldrich) were combined in a 500 ml three neck flask. The flask was equipped with a magnetic stirring bar, a Dean-Stark Trap, a condenser, two one end sealed tube for thermal couples. The flask was heated with a heating mantle and this heating mantle was set on a magnetic stirrer. The heating mantle was controlled at 300° C., while the mixture temperature in the flask was in a 221-223° C. range and the overhead mixture temperature was in the range of 211-215° C. Kept in these reaction conditions for 6 hours, then filtered, the liquid product obtained resulted in the yield a molybdenum salt with 15.78 wt % Mo and a molybdic acid conversion of 94.4 wt %.

### Example 5

20 grams of molybdic acid (Alfa Aecar) and 72 gram of 2-ethylhexanoic acid (Aldrich) were combined in a 500 ml three neck flask. The flask was equipped with a magnetic stirring bar, a Dean-Stark Trap, a condenser, two one end sealed tube for thermal couples. The flask was heated with a heating mantle and this heating mantle was set on a magnetic stirrer. The heating mantle was controlled at 320° C., while the mixture temperature in the flask was in a 214-217° C. range and the overhead mixture temperature was in the range of 214−207° C. Kept in these reaction conditions, combined with stirring for 6 hours, then filtered, the liquid product obtained resulted in the yield a molybdenum salt with 15.80 wt % Mo and a molybdic acid conversion of 94.9 wt %.

### Example 6

20 grams of molybdic acid (Alfa Aecar) and 72 gram of 2-ethylhexanoic acid (Aldrich) were combined in a 500 ml three neck flask. The flask was equipped with a magnetic stirring bar, a Dean-Stark Trap, a condenser, two one end sealed tube for thermal couples. The flask was heated with a heating mantle and this heating mantle was set on a magnetic stirrer. The heating mantle was controlled at 320° C., while the mixture temperature in the flask was in a 214-217° C. range and the overhead mixture temperature was in the range of 214-207° C. Kept in these reaction conditions for 4 hours, then filtered, the liquid product obtained resulted in the yield a molybdenum salt with 14.37 wt % Mo and a molybdic acid conversion of 87.1 wt %.

### Example 7

20 grams of molybdic acid (Alfa Aecar) and 108 gram of 2-ethylhexanoic acid (Aldrich) were combined in a 500 ml three neck flask. The flask was equipped with a magnetic stirring bar, a Dean-Stark Trap, a condenser, two one end sealed tube for thermal couples. The flask was heated with a heating mantle and this heating mantle was set on a magnetic stirrer. The heating mantle was controlled at 300° C., while the mixture temperature in the flask was in a 221-223° C. range and the overhead mixture temperature was in the range of 196-211° C. Kept in these reaction conditions, combined with stirring for 6 hours, then filtered, the liquid product obtained resulted in the yield a molybdenum salt with 10.83 wt % Mo and a molybdic acid conversion of 97.8 wt %.

### Example 8

20 grams of molybdic acid (Alfa Aecar) and 72 gram of 2-ethylhexanoic acid (Aldrich) were combined in a 500 ml three neck flask. The flask was equipped with a magnetic stirring bar, a Dean-Stark Trap, two condensers connected in series, two one end sealed tube for thermal couples. The flask was heated with a heating mantle and this heating mantle was set on a magnetic stirrer. A low vacuum (−5 mmHg) was applied and connected on the top of a condenser to help remove the generated water. Two buffer bottles were connected to the mechanical vacuum pump and a needle valve was connected to the vacuum system to adjust the vacuum. The heating mantle was controlled at 200° C., while the mixture temperature in the flask was in a 150-161° C. range and the over head mixture temperature was in the range of 131−143° C. Kept in these reaction conditions, combined with stirring for 6 hours, then filtered, the liquid product obtained resulted in the yield a K molybdenum salt with 0.87 wt % Mo and a molybdic acid conversion of 5.2 wt %.

### Example 9

The synthesis process and conditions were the same as in example 7. Post reaction, the heating element was shut down and then a low vacuum system was connected on the top of a condenser to help refluxing and removing non-reacted acid to increase the Mo concentrations. Two buffer bottles were connected to the mechanical vacuum pump and a needle valve was connected to the vacuum system to adjust the vacuum. The vacuum was adjusted between −5 mmHg and −10 mmHg (the temperature of the mixture gradually decreased and the vacuum then needed to increase) and this process lasted for 30 hours. The collected liquid in the Dean-Stark trap was removed by opening the valve. The mixture in the flask was then filtered to obtain a liquid product which yielded a molybdenum salt with 12.24 wt % Mo instead of 10.83 wt %.

### Example 10

17.8 grams of molybdenum trioxide (Aldrich) and 72 gram of 2-ethylhexanoic acid (Aldrich) were combined in a 500 ml three neck flask. The flask was equipped with a magnetic stirring bar, a Dean-Stark Trap, a condenser, two one end sealed tube for thermal couples. The flask was heated with a heating mantle and this heating mantle was set on a magnetic stirrer. The heating mantle was controlled at 300° C., while the mixture temperature in the flask was in a 227-231° C. range and the overhead mixture temperature was in the range of 225−229° C. Kept in these reaction conditions for 6 hours, then filtered, the liquid product obtained resulted in the yield a molybdenum salt with 0.57 wt % Mo and a molybdenum trioxide conversion of 3.2 wt %.

### Example 11

Example 11 describes the protection of the hydrocarbon soluble catalyst precursor from concentration variations over long periods of time. 50 grams of hydrogenated vegetable oil was added to a 500 ml beaker. This beaker was put in an oven at a temperature of 150° C. for 1 hour and the hydrogenated vegetable oil melted. Then, 50 grams of example 5's catalyst precursor was added to the beaker with vigorous stirring for 5 minutes. The mixture was then dropped to a water cooled stainless steel surface. The mixture immediately solidified when it came into contact with the cold metal surface. A mixture with a Mo concentration of 7.9 wt % was obtained.

### Example 12

Example 12 describes the use of a catalyst precursor as in example 11 and a commercially available molybdenum catalyst precursor for a hydrocracking process of vacuum residue. The initial API of the vacuum residue was API_{15.6}=5.2. 80 grams of 150° C. vacuum residue was added in a weighed 300 ml autoclave, and then the catalyst precursor was added into the reactor. The amount of catalyst precursor in vacuum residue was in the designed concentration of Mo. After sealing the reactor, the reactor was weighted and then flushed with nitrogen 3 times. After checking for leakage of the reaction with nitrogen, the reactor was flushed with hydrogen three times and filled with hydrogen to the designed pressure. The autoclave was then heated. The stirrer started when the mixture's temperature in the reactor reached 150° C. The autoclave was continuously heated until the mixture temperature reached 320° C., then was kept at this temperature with stirring for 30 minutes to vulcanize the catalyst precursor. Then the autoclave was heated to the designed temperature to start the reaction. The reaction condition was set to the designed reaction time and then the reactor was quickly cooled with water cooling coils in the reactor to achieve a temperature lower than 330° C. in 30 seconds. After the reactor was cooled to room temperature, the reactor was weighed, then, carefully and slowly the gas in the reactor was released. The weight of the reactor was also measured after the gas was completely released. The quantity of liquid and solid products was then calculated from the difference between this weight and the empty reactor weight. The liquid product API was measured, the coke in the liquid product was measured and the coke on the wall of the reactor, as well as on the cooling coils were collected and measured.

TABLE 1
Reaction results for vacuum residue hydroprocessing in autoclave

| Catalyst | Example 11 | Molybdenum Octoate |
|---|---|---|
| Reaction time, in min. | 60 | 60 |
| Mo concentration, in ppm | 1000 | 1000 |
| Reaction temperature, in ° C. | 425 | 425 |
| Initial Hydrogen pressure, in psi | 1000 | 1000 |
| API_{15.6° C.} | 16.0 | 17.5 |
| API barrel | 15.08 | 16.48 |
| Coke yield, in wt % | 0.74 | 1.23 |
| Liquid weight yield, in wt % | 94.23 | 94.18 |
| Liquid volume yield, in % | 103.4 | 104.9 |

1. A method of making a molybdenum catalyst precursor for the hydroprocessing of heavy oil/residue, comprising:
Providing a molybdenum sources;
Providing carboxylic acids having at least one carboxylic group that is reactive with molybdenum atoms; and the molar ratio of molybdenum atoms to carboxylic acid molecules in the range of 1:4 to 1:10;

2. A method as in claim 1, wherein a vacuum is employed to help remove water generated during the synthesis of catalyst precursors.

3. A method as in claim 2, wherein a low vacuum in the range of −4 mmHg˜−8 mmHg is employed.

4. A method as in claim 3, wherein a low vacuum is employed when controlled heating temperature is below 200° C.

5. A method as in claim 3, wherein the vacuum is employed intermittently or continuously.

6. A method as in claim 3, wherein a low vacuum is not necessary to be employed when the synthesis temperature is higher than 200° C.

7. A method as in claim 1, wherein the carboxylic acid has a range of 7 and 18 carbon atoms.

8. A method as in claim 1, wherein the heating element, such as a furnace, a heating mantle or a sand bath, is, at least, regulated to the temperature at which the mixture temperature in the reactor reaches to the boiling point of used carboxylic acid.

9. The heating element temperature exceeds the lowest temperature described in claim 8 to accelerate the reaction and increase Mo conversion. The heating element is controlled in the temperature range of 275-380° C.

10. A method as in claim 1, wherein a high ratio of carboxylic acid to molybdenum atoms is applied to increase the Mo conversion, then combined with low vacuum to remove non-reacted acid to augment Mo concentrations in the final product without greatly increasing synthesis time.

11. A method as in claim 1, wherein the process avoids Mo concentration variations by mixing the molybdenum catalyst precursor with solid organic chemicals.

12. A method as in claim 11, where the solid organic chemicals can be wax, hydrogenated vegetable oils, vacuum residues, and the like.

13. A method as in claim 11, where the final catalyst precursors are in solid state.
